(19) United States
(12) Patent Application Publication
(10) Pub. No.: US 2022/0227196 A1
(43) Pub. Date: Jul. 21, 2022

(54) ELECTRONICALLY OPEN-LOOP OR CLOSED-LOOP CONTROLLED AIR SPRING SYSTEM, AIR SPRING SYSTEM AND METHOD FOR HEIGHT REGULATION OF A VEHICLE

(71) Applicant: ZF CV Systems Hannover GmbH, Hannover (DE)

(72) Inventors: Joerg Meier, Hessisch Oldendorf (DE); Joerg Scharpenberg, Burgwedel (DE); Matthias Heinrich Von Schwanewede, Hannover (DE)

(21) Appl. No.: 17/613,950

(22) PCT Filed: May 13, 2020
(86) PCT No.: PCT/EP2020/063266

§ 371 Date: Nov. 24, 2021

(30) Foreign Application Priority Data
May 27, 2019 (DE) 10 2019 114 150.8
Oct. 30, 2019 (DE) 10 2019 129 371.5

(51) Int. Cl. B60G 17/015; B60G 11/27

(52) U.S. Cl. CPC B60G 17/0155; B60G 11/27; B60G 2202/152; B60G 2400/252; B60G 2500/30; B60G 2600/17; B60G 2800/914; B60G 2600/181; B60G 2500/202

(57) ABSTRACT

A controlled air spring system with a compressed air supply for height regulation of a vehicle includes a number of air springs and a reservoir for the storage of compressed air, a number of switching valves for height regulation, and a controller configured to actuate the number of switching valves. The at least one switching valve is actuated with a number of sequential switching periods and switches over in a switching period, between a first switching state with an open valve state and a second switching state with a closed valve state, the switching period of the number of sequential shifting periods having the open valve state and the closed valve state. The controller is configured to set a speed for a height change of the height regulation. The setting of the speed takes place via an open/closed parameter.

### CROSS REFERENCE TO RELATED APPLICATIONS

This application is a U.S. National Phase application under 35 U.S.C. § 371 of International Application No. PCT/EP2020/063266, filed on May 13, 2020, and claims benefit to German Patent Application No. DE 10 2019 114 150.8, filed on May 27, 2019 and to German Patent Application No. DE 10 2019 129 371.5, filed on Oct. 30, 2019. The International Application was published in German on Dec. 3, 2020 as WO/2020/239440 A1 under PCT Article 21(2).

### FIELD

The disclosure relates to an electronically open-loop or closed-loop controlled air spring system with a compressed air supply for height regulation of a vehicle, an air spring installation with such an air spring system, and to a method for the height regulation of a vehicle.

### BACKGROUND

An air spring system is used in vehicles of all types, in particular for the height regulation of the vehicle, that is to say for the regulation of the spacing between the vehicle axle and the vehicle body. Said air spring system usually comprises a reservoir which provides compressed air from a compressed air supply system which is connected upstream of the air spring system, and, in addition, a number of air spring valves which are connected pneumatically to a common line (gallery), and subsequently, in a manner which is assigned to the former, a corresponding number of air springs. Here, the air springs as a rule comprise a number of air bellows which, as the filling increases, can lift the vehicle body and, as the filling decreases, can correspondingly lower it.

A compressed air supply system for use in conjunction with an air spring system, for example in an air spring installation, is operated by way of compressed air from a compressed air feed, for example within a pressure level of from 5 to 20 bar. The compressed air is made available by way of an air compressor (compressor) of the compressed air feed. The compressed air feed is connected pneumatically to a compressed air connector for the supply of the air spring system. In order to ensure long term operation of the compressed air supply system, it additionally comprises an air dryer, by way of which the compressed air is to be dried. As a result, the accumulation of moisture in the air spring installation is avoided, which is conducive to the protection of the air spring installation against defects.

In the case of a growing spacing between the vehicle axle and the vehicle body or the ground clearance, the spring deflections become longer, and even relatively great ground bumps can be overcome in this way, without contact with the vehicle body occurring. Systems of this type are used in off road vehicles and sport utility vehicles (SUVs). In the case of SUVs, in particular, it is desirable in the case of high performance engines to firstly provide the vehicle with a comparatively low ground clearance for high speeds on road and secondly to provide it with a comparatively great ground clearance for off roading. It is therefore desirable firstly for a change in the ground clearance to be implemented as rapidly as possible, which increases the requirements with regard to the performance of the compressed air supply system, and secondly it is desirable for a change in the ground clearance to be implemented, without it being necessary for the compressed air supply system to be operated permanently; in addition, the change in the ground clearance desirably takes place as far as possible without graduations which are perceptible to the vehicle driver. Furthermore, it would be desirable for it to be possible for the change in the ground clearance to be adapted individually for the front axle and the rear axle and/or for individual air springs, in order for it to be possible, for example, for a (nonuniform) loading of the vehicle or the like to be compensated for.

DE 10 2005 030 467 B4 has disclosed the air spring system, mentioned at the outset, for a height regulation of a vehicle with air springs, by way of which height regulation a predefined spacing of the vehicle cell from the vehicle axle can be maintained by way of the air springs being filled from a compressed air store or being emptied in a manner which is dependent on the vehicle loading. At least one central aerating valve is provided for the supply of the air bellows valves, which are assigned to the air bellows of the front axle (VA) and the rear axle (HA), with compressed air from a compressed air store. In order for uniform lifting and/or lowering to be achieved, the air bellows valves which are assigned to the air spring bellows on the front axle and the rear axle are loaded with a relatively high pulse frequency. Switching over of the central aerating valve cannot be achieved by way of the relatively high pulse frequency. Rather, in order to ensure an identical height regulation on the front axle and the rear axle, the invention provides a throttle with an adjustable or constant flow cross section, and the central aerating valve and a central venting valve. The throttle and valves are then intended to compensate for a different pressure build up time or pressure dissipation time in the air bellows of the air springs of the front axle and the rear axle. An air spring system of this type can still be improved.

The abovementioned solution requires, in particular, an increased structural complexity, that is to say the solution provides the use of two additional valves and a flow resistance element in the form of a throttle with a flow cross section which is preferably even variable.

### SUMMARY

In an embodiment, the present disclosure provides an electronically open-loop or closed-loop controlled air spring system with a compressed air supply for height regulation of a vehicle. The air spring system includes a number of air springs and a reservoir for the storage of compressed air, a number of switching valves for height regulation, and a controller configured to actuate the number of switching valves. The at least one switching valve is actuated with a number of sequential switching periods and switches over in a switching period, between a first switching state with an open valve state and a second switching state with a closed valve state, the switching period of the number of sequential shifting periods having the open valve state and the closed valve state. The controller is configured to set a speed for a height change of the height regulation. The setting of the speed takes place via an open/closed parameter, via which an open proportion of the open valve state and/or a closed proportion of the closed valve state in the switching period can be specified.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 diagrammatically shows one preferred embodiment of the air spring system, a compressed air supply installation being shown diagrammatically, furthermore, and the two assemblies in combination resulting in an air spring installation for the height regulation of a vehicle, and further diagrammatically shows a closed-loop control pulse of a number of consecutive closed-loop control pulses for the actuation of a number of switching valves;

FIG. 2 diagrammatically shows a further preferred embodiment of the air spring installation, an alternative arrangement of the venting line and the throttle or flow resistance element of that type being shown diagrammatically here, which alternative arrangement serves for the smoothing of the air volumetric flow;

FIG. 3 diagrammatically shows the adaptation of the raising speed and/or lowering speed achieved by way of the air spring system, via an open/closed parameter of a switching valve of a number of switching valves;

FIG. 4A shows, on the basis of measured values, in a view A, firstly the influence of the frequency of the switching period on the temporal course of the height regulation of the vehicle, in particular of the rear axle and the front axle of the vehicle, between a starting height and a target height within a height interval, and the influence of the open/closed parameter on the resulting speed of the height regulation of the vehicle in the case of a height regulation of the vehicle out of the reservoir, and in a view B, a reference measurement is shown relating to the height regulation of a vehicle by means of a customary actuation of the corresponding switching valves;

FIG. 4B shows, in a view A, the temporal course of the height regulation of the vehicle, in particular of the rear axle and the front axle of the vehicle, for a further value pair of frequency and open/closed parameter, and in a view B, the reference measurement is likewise shown;

FIG. 4C shows, in a view A, the temporal course of the height regulation of the vehicle, in particular of the rear axle and the front axle of the vehicle, for a further, different value pair of frequency and open/closed parameter, and in a view B, the reference measurement is likewise shown;

FIG. 4D shows, in a view A, the temporal course of the height regulation of the vehicle, in particular of the rear axle and the front axle of the vehicle, for a further, once again different value pair of frequency and open/closed parameter, and in a view B, the reference measurement is likewise shown; and

FIG. 5 diagrammatically shows a flow chart with respect to a method for the height regulation of a vehicle out of the reservoir by means of an air spring system.

### DETAILED DESCRIPTION

The present disclosure provides an apparatus and a method which are improved with regard to the prior art. In particular, an alternative solution to the prior art is specified, which alternative solution not only eliminates the disadvantages which result from an increased structural complexity, but rather also achieves the height regulation of the vehicle in an improved way.

The disclosure proceeds from the observation that the raising speed, out of the reservoir in the case of the height regulation of the vehicle, is dependent, for example, on the loading of the vehicle, the available pressure in the reservoir, the effective valve cross sections of the valves which are used, the counter-pressure of the air springs and more of that type. The result of this is that the experience of the height regulation of the vehicle, in particular the raising speed, changes for a driver in a manner which is dependent on the abovementioned factors. An experience of the height regulation as a constant process therefore does not normally take place.

It is admittedly fundamentally known, as described at the outset, that the air bellows valves which are assigned to the air spring bellows on the front axle and the rear axle are loaded with a relatively high pulse frequency.

A closed-loop controlled air volumetric flow can be generated in the case of the height regulation of the vehicle by means of pulsed actuation of a switching valve or a number of switching valves. Said closed-loop controlled air volumetric flow can then be fed to the air springs of the air spring system, as a result of which a more uniform raising speed and therefore a more uniform experience of the height regulation of the vehicle by way of the driver are made possible.

In contrast, the present disclosure has recognized that the setting of the speed for a height change of the height regulation, in particular raising speed and/or lowering speed, takes place in an advantageous way, in particular, via an open/closed parameter. The open/closed parameter is formed from a ratio of an open proportion of the open valve state to a closed proportion of the closed valve state in a switching period, during a sequence of sequential switching periods during the height regulation of the vehicle.

In this context, the ratio of open proportion to closed proportion of the switching valve denotes, for example, two consecutive time intervals during a switching period, a first time interval describing the switching valve in the open state, and a second time interval describing the switching valve in the following closed state. An open/closed parameter of the switching valve can then be derived from said ratio, which open/closed parameter in a particularly advantageous way defines the raising speed and/or the lowering speed in the case of the height regulation of the vehicle. The desired raising speed and/or the lowering speed can be set in a simple way by way of adaptation of the open/closed parameter. This can take place in such a way that, in the case of a desired reduction of the raising speed, a lower ratio is selected. In particular, the open proportion of the switching valve in a switching period in relation to the closed proportion of the switching valve in said switching period can be reduced. In the case of a desired increase of the raising speed, the open proportion of the switching valve in a switching period is to be increased correspondingly, in relation to the closed proportion of the switching valve in said switching period.

Said ratios apply identically in the case of a setting of the lowering speed. For the case where, for example, the lowering speed is to be reduced, in particular, the open proportion of the switching valve in a switching period in relation to the closed proportion of the switching valve in said switching period is likewise to be reduced.

The above-described switching pattern is advantageously to be understood as a pulse width modulation which, by way of a modulated pulse width, brings about actual, preferably complete, opening and closing of the switching valve. As a result, a desired air volumetric flow is then generated, and the resulting raising speed and/or lowering speed of the height regulation is controlled in this way. In other words, the pulse width modulation is designed in such a way that it is ensured that the switching valve both opens completely and closes completely within a switching period. The open proportion of the open valve state and the closed proportion of the closed valve state in a switching period of a sequence of sequential switching periods are then defined in accordance with the open/closed parameter. In this respect, a switching valve of this type is also called a switching valve which is switched in an actuated manner in the following text.

In accordance with the concept of the disclosure, it is additionally advantageously provided for the height regulation of the vehicle to be implemented without additional components. That is to say, in contrast to the prior art, the concept of the disclosure leads not only advantageously to a less expensive height regulation of the vehicle by way of further components being saved, but rather likewise leads as a consequence to a solution which requires less maintenance and is more fail-safe.

By way of an actuation of suitable switching valves, for example by way of an actuation of venting valves, the height regulation of the vehicle can be transferred in an analogous manner to the lowering operation of the vehicle. In addition, an actuation of a switching valve and/or a number of switching valves is required in a manner which is dependent on the specific embodiment. The following developments are intended to be correspondingly applicable to one switching valve and/or a number of switching valves.

Furthermore, the disclosure provides an air spring installation with an air spring system according to the disclosure and comprising, furthermore, a compressed air supply system, with a compressed air feed, a compressed air connector, a main pneumatic line between the compressed air feed and the compressed air connector, which main pneumatic line comprises an air dryer, and a compressed air supply line, between the compressed air connector and the air spring system.

Furthermore, the air spring installation comprises a venting connector and a venting line between the compressed air feed and the venting connector, which venting line comprises a venting valve, the main pneumatic line and/or the compressed air supply line comprising at least one throttle or flow resistance element of that type.

Furthermore, it is provided that the venting valve can be actuated, and the controller is configured, furthermore, for the actuation of the venting valve and for the setting of the lowering speed of the height regulation, a setting of the lowering speed of the height regulation likewise taking place via the open/closed parameter. In addition, it is provided that the throttle or flow resistance element of that type is configured for the smoothing of the raising speed and/or the lowering speed of the height regulation of the vehicle. Here, the advantages of the air spring system are advantageously transferred to the air spring installation.

In particular, in one development, the at least one throttle or flow resistance element of that type is advantageously arranged in the main pneumatic line between the air dryer and the compressed air connector, and/or is arranged in the compressed air supply line between the compressed air connector and the air spring system.

It is advantageously provided that the speed of the height change of the height regulation is a raising speed or a lowering speed, the controller being configured to set the raising speed and/or the lowering speed. Specifically, this means that both a more uniform raising speed and a more uniform lowering speed are advantageously achieved, and therefore a more uniform experience of the height regulation of the vehicle by way of the driver is made possible.

It is provided within the context of one preferred development that the height regulation of the vehicle takes place within a permissible height interval, between a minimum height and a maximum height. Specifically, this means that the value range of the height regulation is restricted to values which are appropriate in terms of technology and driving dynamics. In this way, an incorrect operation by way of the driver of the vehicle is advantageously avoided a priori.

Furthermore, it is advantageously provided that the dimension of the open/closed parameter can be specified in percent. Scaling of the open/closed parameter to a percent scale makes, in particular, an intuitive setting of a desired raising speed in the case of the height regulation of the vehicle by the driver possible or, in the case of an automatic setting of the raising speed by means of a control device or the like, makes a simple handling of the open/closed parameter in terms of program technology possible.

In addition, it is provided in one development that the open/closed parameter can assume any desired value in the value range between 0% and 100%. As a consequence, a value of 0% then forms the lower limit case of a continuously closed switching valve of a number of switching valves and, in an analogous manner, the limit case of a continuously closed switching valve of a number of switching valves is represented by way of a value of 100%. Specifically, this means that the state space of the switching valve is described completely by way of the open/closed parameter in the value range between 0% and 100%. Therefore, a simple possibility is advantageously provided of firstly modulating the pulse width of the open/closed parameter, in order to adapt it to the respective driving situation, and secondly, for example, to keep the switching valve closed as long as no height adaptation of the vehicle is required.

In this context, however, it is provided in one development for, in particular, three clearly delimited and technologically particularly advantageous value ranges to be defined. To this end, it is provided in a first development that the open/closed parameter assumes, in particular, a value from the value range between 25% and 35%. Furthermore, it is provided in a second development that the open/closed parameter assumes, in particular, a value from the value range between 45% and 55%. In addition, it is provided in a third development that the open/closed parameter assumes, in particular, a value from the value range between 65% and 75%.

It can be seen from the three abovementioned preferred value ranges that the first value range between 25% and 35% corresponds with a slow speed for a height change of the height regulation, in particular raising speed and/or lowering speed, the second value range between 450 and 55° corresponds with a medium speed for a height change of the height regulation, in particular standard raising speed and/or standard lowering speed, and the third value range between 65% and 55% corresponds with a rapid speed for a height change of the height regulation, in particular raising speed and/or lowering speed, relative to the two first-mentioned value ranges. It is therefore advantageously possible for a preferred raising speed and/or lowering speed to be defined, in a manual or automated manner, which raising speed and/or lowering speed takes into consideration boundary conditions which are relevant for the height adaptation of the vehicle, such as, for example, the available reservoir pressure, the vehicle loading, the current driving situation and the like, in a way which is particularly simple and intuitive to a vehicle driver. It is thus conceivable, for example, that a rapid raising speed is to be preferred in the case of a rapid transition from a paved tar road to an unpaved gravel track or the like.

It is provided within the context of one preferred development that the value of the open/closed parameter is variable during the height regulation of the vehicle out of the reservoir. Specifically, this means that the open/closed parameter can be adapted dynamically, in particular even during a running height regulation. It is therefore advantageously possible to react directly in terms of closed-loop control technology to variable boundary conditions which influence the speed for a height change of the height regulation, in particular the raising and/or lowering speed, such as, for example, decreasing reservoir pressure. In addition, this development is advantageous as soon as the underlying surface conditions change in rapid succession during driving and the height regulation takes place, in particular, in an automatic manner, since, during a running raising and/or lowering operation, said operation can then be adapted in such a way that the rapidly changing underlying surface conditions can be represented, for example by way of a mean value between that height level of the vehicle which is preferred in each case for a certain underlying surface.

In particular, it is provided in one development that the raising speed is constant in the case of the height regulation of the vehicle out of the reservoir. This means, in particular, that the raising speed and/or the lowering speed makes/makes an infinitely variable height regulation of the vehicle possible, with acknowledgement in terms of closed-loop control technology of restrictive boundary conditions such as available reservoir pressure and the like. This results in the advantage that the height regulation takes place without perceptible graduations for a driver, that is to say is perceived over time neither as accelerating nor as decelerating, in particular.

A further preferred development provides that the speed for a height change of the height regulation, in particular the raising speed and/or the lowering speed, takes place via an evaluation of height level values within the permissible height interval. Specifically, this means that the speed for a height change of the height regulation, in particular raising speed and/or the lowering speed, is set via a constant time-distance ratio if a constant raising speed and/or lowering speed are/is desired. That is to say, the height increment which is measured or determined in some other way is traveled in each case within identical time increments. This results in the advantage that an alternative closed-loop control approach is available in the case of failure of the sensor system which as a rule closed-loop controls the height regulation of the vehicle out of the reservoir.

It is provided in one development that the controller is configured to generate a constant air volumetric flow in the case of the height regulation of the vehicle out of the reservoir. A constant air volumetric flow in the direction of the air springs is constituting for a constant raising speed; therefore, the constant air volumetric flow results directly in an infinitely variable raising and/or lowering movement of the vehicle, which movement ideally cannot be perceived by the driver.

In addition, it is provided in one particularly preferred development that the frequency of the switching period of the actuation of the at least one switching valve of the number of switching valves is defined in such a way that the height regulation of the vehicle out of the reservoir takes place uniformly, in particular without perceptible graduations. Specifically, this means that, if the frequency of the switching period is selected to be too small, that is to say if the opening and closing of the switching valve takes place too slowly, the result is a step-shaped raising and/or lowering profile which is clearly perceptible to the driver. This undesired behavior can be avoided in a particularly advantageous way, that is to say in a way which is simple in terms of closed-loop control technology, by way of a suitable selection of the frequency of the switching period.

In the context of the above development, it is provided that the frequency of the switching period is selected, in particular, from a value range, comprising the values of greater than or equal to 5 Hz and less than or equal to 20 Hz. The value of the frequency of the switching period lies, in particular, in this advantageous value range, since a perceivable graduation of the raising and/or lowering operation is brought about at a frequency below 5 Hz, which graduation is smoothed increasingly as the frequency increases. Therefore, there is no longer an improvement which can be perceived by the driver for values above 20 Hz. In contrast, an increasing frequency brings about increasing mechanical loading of the switching valve of the number of switching valves. Therefore, the frequency advantageously lies within a range between 5 Hz and 20 Hz.

In particular, it is provided in one development that the speed for a height change of the height regulation, in particular raising speed and/or lowering speed, can be set differently on a front axle and/or a rear axle in the case of the height regulation of the vehicle out of the reservoir. Specifically, this means that a dynamic height compensation of the vehicle is made possible in accordance with said development. Vehicles as a rule have a nonuniform weight distribution in the loaded and in the unloaded state, which nonuniform weight distribution has a different effect on the front axle than on the rear axle. If this circumstance is not taken into account, the result is differently rapid raising and lowering on the front axle than the rear axle in a manner which is dependent on the loading and the like. As a result of the specific development, this problem is solved in an advantageous way by way of differently adjustable raising speeds and/or lowering speeds on the axles.

It is provided in a further preferred development that the speed for a height change of the height regulation, in particular raising speed and/or the lowering speed, can be set individually for each air spring of the number of air springs in the case of the height regulation of the vehicle out of the reservoir. Specifically, this means that the speed for a height change of the height regulation, in particular raising speed and/or the lowering speed, can be set individually for each air spring. In particular, in the case of off road vehicles which make it necessary for in some cases significant height differences between the axles, but also between the individual wheels, relative to the vehicle body to be compensated for, advantages result from said development. For example, it can become necessary for one of the front wheels to be raised and/or lowered as rapidly as possible relative to one of the rear wheels, in order to effectively prevent grounding of the vehicle.

In particular, it is provided in one development that the number of switching valves is a number of bellows valves which are switched in an actuated manner, configured for the setting of the speed for a height change of the height regulation, in particular raising speed and/or the lowering speed of the height regulation of the vehicle. Specifically, this means that, in particular, the bellows valves of the individual air springs are switched in an actuated manner here, which results in the advantage that the raising and lowering operation of the vehicle can be set individually for each air spring, to be precise in such a way that the raising and lowering operation is not perceptible to the driver and, in particular, takes place without perceptible graduations.

It is provided within the context of one preferred development that the at least one switching valve of the number of switching valves is a reservoir valve which is switched in an actuated manner, configured for the setting of the raising speed of the height regulation of the vehicle. Specifically, this means that only the reservoir valve is switched in an actuated manner, in order to achieve uniform raising of the vehicle, in particular without perceptible graduations. Therefore, the complexity in terms of closed-loop control technology is advantageously reduced, since only one switching valve, the reservoir valve, has to be switched in an actuated manner.

In particular, it is provided in one development that the speed is a lowering speed, and the height regulation of the vehicle takes place via venting of the compressed air supply, preferably the compressed air supply system, a number of venting valves being switched in an actuated manner. Specifically, this means that at least one venting valve of the compressed air supply system is switched in an actuated manner, in order to achieve uniform lowering of the vehicle, in particular without perceptible graduations. Therefore, the complexity in terms of closed-loop control technology is advantageously reduced, since only a venting valve which is already present has to be switched in an actuated manner for the setting of the lowering speed.

It is provided within the context of one preferred development that the air dryer of the air spring installation has, furthermore, a volume, the volume of the air dryer being configured as a buffer volume, for the smoothing of the raising speed and/or the lowering speed of the height regulation of the vehicle. By virtue of the fact that the air dryer housing acts as an additional flow resistance which brings about a tolerable pressure drop in the air volumetric flow, damping of the fluctuation values which are associated with the flow is advantageously produced. As a result, the raising and/or lowering movement takes place, in particular, more uniformly in the case of the height regulation of the vehicle.

In addition, it is provided in one preferred development of the air spring installation that the air spring installation comprises, furthermore, a venting connector, a venting line between the compressed air connector and the venting connector, which venting line comprises a venting valve, the main pneumatic line comprising, furthermore, a check valve between the air dryer and the compressed air connector, for shutting off of the components of the compressed air supply system in the direction of the air dryer, it being provided, in particular, that the venting valve can be actuated, and the controller being configured, furthermore, for the actuation of the venting valve and for the setting of the lowering speed of the height regulation, a setting of the lowering speed of the height regulation likewise taking place via the open/closed parameter. It is provided, furthermore, that the compressed air supply line comprises a throttle or flow resistance element of that type, the throttle or flow resistance element of that type being configured for smoothing of the raising speed and/or the lowering speed of the height regulation of the vehicle.

In this way, firstly, the advantages which result by way of an actuation of the switching valves which are involved in the raising operation can be transferred in a simple way to the lowering operation, by way of an actuation of the venting valve of the compressed air supply system. Secondly, it is advantageously possible, by way of the use of a throttle or flow resistance element of that type, arranged in accordance with the abovementioned embodiment, to smooth the controlled air volumetric flow in a particularly advantageous way, which air volumetric flow is generated by way of the controller of the switching valve of a number of switching valves. That is to say, fluctuation values in pressure, speed or the like of the air volumetric flow which are associated with the generation of precisely this air volumetric flow are smoothed or damped effectively and particularly advantageously by way of the provision of a throttle or flow resistance element of that type, with the result that the height regulation of the vehicle is perceived to be correspondingly more uniform by the driver.

In addition, it is provided in one alternative development that the main pneumatic line and the compressed air supply line are continuous between the air dryer and the air spring system, that is to say are free, in particular, from flow resistance elements. This alternative development has recognized in a particularly advantageous way that the volume of the air dryer can likewise assume the function of the throttle which is used in the first development. That is to say, the volume of the air dryer can be used as a buffer volume, in order to damp the fluctuation values which are associated with the generated air volumetric flow. In this way, the height regulation of the vehicle is likewise perceived to be more uniform by the driver in comparison with an embodiment without a measure of this type. Furthermore, said development results in the advantage that the throttle or flow resistance element of that type which is otherwise necessary is redundant. This results in an advantage with regard to complexity, costs and maintenance in comparison with the other developments.

Embodiments will now be described in the following text on the basis of the drawing. Said drawing is not necessarily intended to illustrate the embodiments to scale; rather, where it is expedient for explanation purposes, the drawing is configured in a diagrammatic and/or slightly distorted form. Reference is made to the relevant prior art with regard to supplements to the teachings which can be seen directly from the drawing. It is to be taken into consideration here that a wide variety of modifications and amendments relating to the shape and the detail of one embodiment can be performed, without departing from the general concept of the disclosure. The general concept of the disclosure is not restricted to the exact shape or the detail of the preferred embodiments which are described and shown in the following. In the case of specified dimensional ranges, values which lie within said limits are also intended to be disclosed as limit values, and are intended to be capable of being used and claimed as desired. For the sake of simplicity, identical designations are used in the following text for identical or similar parts or parts with an identical or similar function.

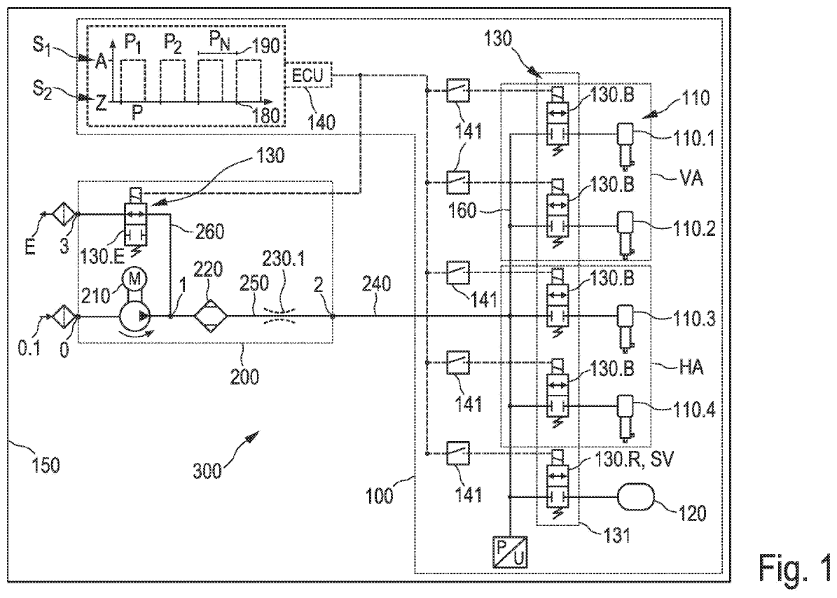

FIG. 1 shows an air spring system 100 and a compressed air supply system 200, the two components in interaction resulting in an air spring installation 300 for a height regulation H_{R} of a vehicle 150. To this end, furthermore, the air spring system 100 comprises a number of air springs 110 and, connected pneumatically to the latter, a number of switching valves 130, said switching valves SV being, in particular, solenoid valves. In the present case, the group of switching valves SV includes, in particular, a bellows valve 130.B, a reservoir valve 130.R or a venting valve 130.E.

Furthermore, the air spring system 100 comprises a reservoir 120 for the storage of compressed air DL and, connected pneumatically to said reservoir 120, once again a switching valve SV, in the present case in the form of the reservoir valve 130.R, in particular likewise a solenoid valve. In addition, the components of the air spring system 100 are connected to one another pneumatically via a gallery 160 which, on the one side via a compressed air supply line 240, conducts compressed air DL from the compressed air supply device 200 directly to the individual air springs 110 or their switching valves SV, that is to say here the bellows valves 130.B, and, on the other side, conducts compressed air DL for storage to the reservoir 120 or once again to its switching valve SV, that is to say the reservoir valve 130.R here, for the purpose of storage of the provided compressed air DL. In addition, in the case of operation of the air spring system 100 out of the reservoir 120, the gallery 160 likewise conducts the compressed air DL which is output by the reservoir 120 to the air springs 110 or their switching valves SV, that is to say their bellows valves 130.B here.

Here, the compressed air supply device 200 which is shown comprises first of all an air feed 0.1, followed by a filter 0, the air which is sucked in being compressed in an air compressor (compressor) 210, in order subsequently to be fed via a compressed air feed 1 to an air dryer 220 which is situated downstream in a main pneumatic line 250. Subsequently, the compressed air flows through a throttle 230 or flow resistance element of that type which acts as a regenerator throttle. Further downstream, the compressed air supply installation 200 is connected pneumatically at a compressed air connector 2 via a compressed air supply line 240 to the air spring system 100 or its gallery 160. In the present case, in addition, the compressed air supply device 200 comprises a venting line 260 between the compressed air feed 1 and the venting connector 3 and, arranged in said venting line 260, a venting valve 130.3 which is in turn configured, in particular, as a solenoid valve.

Here, the operating behavior of the air spring system 100 is provided via a controller (ECU) 140. Via said controller 140, firstly the switching valves SV of the air springs 110, in particular bellows valves 130.B, and secondly the switching valve 130.R of the reservoir 120 are actuated. The actuation of the bellows valves 130.B of the air springs 110 can advantageously take place in such a way that either all the air springs 110 of the vehicle 150 are addressed at the same time, but it is also possible that the bellows valves 130.B which are assigned to the front axle VA and those which are assigned to the rear axle HA are actuated differently, in order, for example, to compensate for a loading of the vehicle 150. Furthermore, the possibility also arises of individual air springs 110 of the air spring system 100 being addressed individually, in order for it to be possible to react in terms of control technology to particularly impassable terrain. For this purpose, the air springs 110 can be actuated individually or jointly in a synchronous manner, in order to perform a corresponding height regulation HR of a vehicle 150 within a height interval H, characterized by a minimum height H₀ and a maximum height H₁.

The number of switching valves 130 shown in FIG. 1 can also be present, for example, in the form of a single valve block 131, however. Said valve block 131 can then be scaled freely in accordance with the air springs which are to be designed in a controllable manner. Specifically, this means that not every air spring 110 has to be individually assigned an individual switching valve SV, but rather open-loop control of a number of air springs 110 is also possible, for example, via a single switching valve SV.

Furthermore, FIG. 1 shows the preferred control diagram in accordance with the concept of the disclosure for the setting of the speed U_{HR} for a height change of the height regulation H_{R}, in particular raising speed U_{H} and/or lowering speed U_{S} of the height regulation H_{R}, of a vehicle 150 out of the reservoir 120. It is provided here that at least one switching valve SV of a number of switching valves 130 is actuated by way of the controller 140, with the result that the at least one switching valve SV is open A during a switching period P over an adjustable time period, whereas it is closed Z in the remaining time period of the switching period P. Furthermore, the switching period P is a period of a number of sequential switching periods P_{N} which are necessary during the height regulation H_{R} of the vehicle 150, in order to raise or to lower the vehicle 150 from a starting height H_{S} to a target height Hz. The speed U_{HR} for a height change of the height regulation H_{R}, in particular raising speed U_{H} and/or lowering speed Us, is then controlled by way of the controller 140, in accordance with the ratio of open A switching valve to closed Z switching valve by means of a parameter which describes the ratio, the open/closed parameter AZP. Here, the open/closed parameter AZP is specified as an open proportion AT_{A} of the open valve state A and/or a closed proportion AT_{Z} of the closed valve state Z in the switching period P. A sequential actuation of the at least one switching valve SV therefore generates a constant volumetric flow from the compressed air DL which is stored in the reservoir 120, which constant volumetric flow loads the air springs 110 for the height regulation H_{R} by means of a constant raising speed U_{H} which results from the constant volumetric flow. Which switching valves SV are actuated for the height regulation H_{R} of the vehicle 150 can be controlled, for example, via switches 141 which are assigned to the controller 140. The raising operation can thus take place via the actuation of the reservoir valve 130.R of the reservoir 120. It is also possible, however, for the number of bellows valves 130.B which are assigned to the air springs 110 to be actuated, in order to realize the lifting operation.

Lowering of the vehicle 150 during the height regulation H_{R}, that is to say setting of the lowering speed Us, preferably takes place in the present case via the compressed air supply system 200. To this end, the controller 140 is configured analogously to actuate the venting valve 130.E, the lowering speed U_{S} likewise being adjustable in an analogous way via the open/closed parameter AZP. Here, the throttle 230 or flow resistance element SWE of that type, in the present case arranged in the main pneumatic line 250, has a smoothing action on the raising and/or lowering operation. As an alternative however, raising and lowering of the vehicle 150 can also take place exclusively via an actuation of the bellows valves 130.B and, assigned to the latter, the air springs 110.

The actuation of the at least one switching valve SV, that is to say, in particular, of a bellows valve 130.B and/or a reservoir valve 130.R and/or a venting valve 130.E, of the number of switching valves 130 by way of the controller 140 can additionally take place in a pulsed manner. A pulsed actuation of this type is advantageously to be understood to mean a pulse width modulation PWM which brings about actual, preferably complete opening A and closing Z of the at least one switching valve SV by way of a modulated pulse width PW. As a result, a desired air volumetric flow LV is then generated, and in this way the resulting raising speed U_{H} and/or lowering speed U_{S} of the height regulation H_{R} are/is controlled. That is to say, the pulse width modulation PWM is designed in such a way that it is ensured that the at least one switching valve SV both completely opens A and completely closes Z within a switching period P.

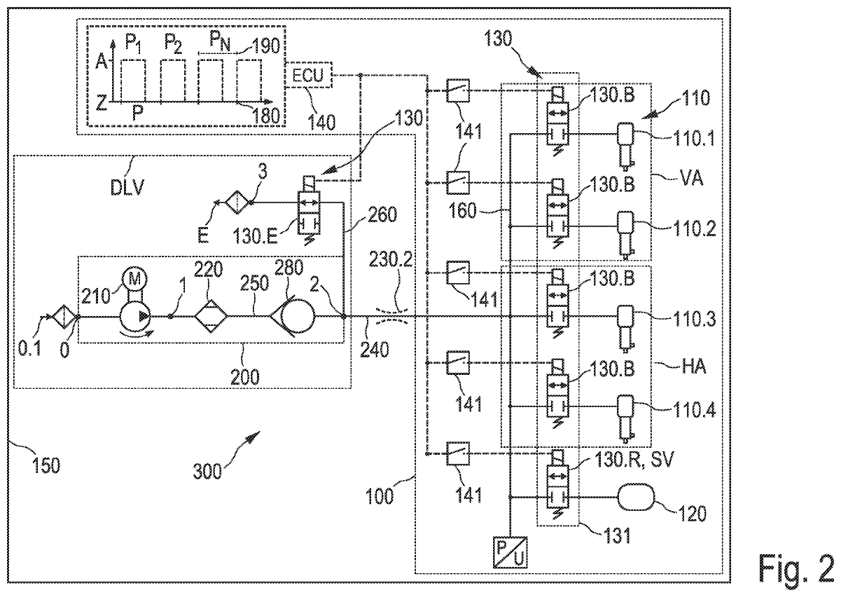

In this regard, FIG. 1 and FIG. 2 by way of example describe a first and a second embodiment of an air spring installation 300 which comprises an air spring system 100 in accordance with the concept of the disclosure. Furthermore, the air spring installation 300 comprises: a compressed air supply system 200, with a compressed air feed 1, a compressed air connector 2, a main pneumatic line 250 between the compressed air feed 1 and the compressed air connector 2, which main pneumatic line 250 comprises an air dryer 220, and a compressed air supply line 240, between the compressed air connector 2 and the air spring system 100, and a venting connector 3, a venting line 260 between the compressed air feed 1 and the venting connector 3, which venting line 260 comprises a venting valve 130.E, the main pneumatic line 250 and/or the compressed air supply line 240 having at least one throttle 230 or flow resistance element SWE of that type, characterized in that the venting valve 130.E can be actuated, and the controller 140 is configured, furthermore, for the actuation of the venting valve 130.E and for the setting of the lowering speed U_{S} of the height regulation H_{R}, a setting of the lowering speed Us of the height regulation H_{R} taking place via the open/closed parameter AZP, and the throttle 230 or flow resistance element SWE of that type being configured for the smoothing GL of the raising speed U_{H} and/or the lowering speed U_{S} of the height regulation H_{R} of the vehicle 150.

In the embodiment of FIG. 1, the at least one throttle 230 (shown as first throttle 230.1 and denoted at the top by “throttle 230”) or flow resistance element SWE of that type is arranged only in the main pneumatic line 250 between the air dryer 220 and the compressed air connector 2.

In the embodiment of FIG. 2, the throttle 230 (shown as second throttle 230.2) or flow resistance element SWE of that type is arranged only in the compressed air supply line 240 between the compressed air connector 2 and the air spring system 100.

In a further embodiment (not shown here), the first and the second throttle 230.1, 230.2 can also be arranged in the main pneumatic line 250 and the compressed air supply line 240.

In the following text, FIG. 2 shows the abovementioned embodiment with the second throttle 230.2 only in the compressed air supply line 240 between the compressed air connector 2 and the air spring system 100; this is again denoted by “throttle 230” in the following text.

To this end, FIG. 2 once again shows an air spring installation 300, comprising an air spring system 100 in accordance with the concept of the disclosure, and a compressed air supply system 200, the compressed air supply system 200 comprising, instead of the throttle 230 from FIG. 1, a check valve 280 in the main pneumatic line 250. In the present case, in addition, the venting line 260 with the venting valve 130.E is arranged between the compressed air connector 2 and the venting connector 3, in order, despite the check valve 280, to realize the lowering operation of the height regulation H_{R} of the vehicle 150 via an actuation ANS of the venting valve 130.E by means of the controller 140.

In the present case, in addition, FIG. 2 shows one preferred development of the concept of the disclosure, a throttle 230 or flow resistance element SWE of that type being provided, in order to damp fluctuation values of the air volumetric flow which is generated by way of an actuation of a switching valve SV by way of the controller 140. That is to say, the throttle 230 generates an additional flow resistance which leads to an additional, but advantageous pressure drop in the air volumetric flow LV. Said pressure drop then has a damping action on the fluctuation values such as pressure, speed and the like which are associated with the air volumetric flow LV. As a result, this leads to a more uniform speed U_{HR} for a height change of the height regulation H_{R}, in particular raising speed U_{H} during the height regulation H_{R} of the vehicle 150 out of the reservoir 120, or to a more uniform lowering speed U_{S} in the case of lowering of the vehicle 150 via an actuation ANS of the venting valve 130.E of the compressed air supply system 200. To this end, in the present case, the throttle 230 is arranged in the compressed air supply line 240 between the compressed air connector 2 and the gallery 160 of the air spring system 100.

Furthermore, it is provided in a first alternative embodiment that the throttle 230 or flow resistance element of that type is arranged in the gallery 160, in order to assume there an identical function as described above for the case of the arrangement in the compressed air supply line 240. Furthermore, it is provided in a second alternative embodiment that the throttle 230 or flow resistance element of that type (and the check valve 280) are dispensed with completely and, for advantageous smoothing GL of the air volumetric flow, the air dryer 220 in the main pneumatic line 250 assumes the function of the throttle 230 in an identical manner. As a result of this measure, an additional component can be dispensed with, without having to accept losses in the advantageous function.

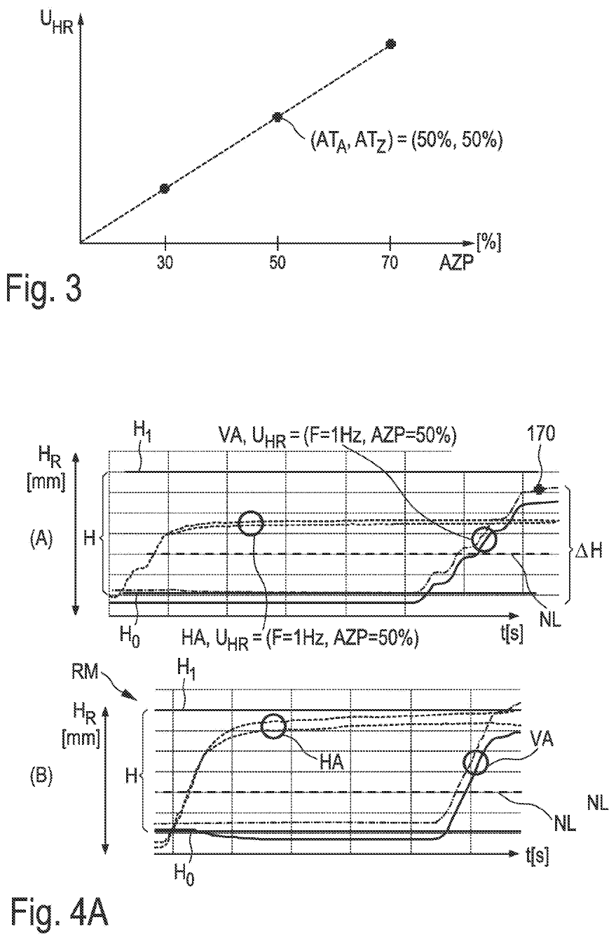

FIG. 3 shows three preferred setting ratios of the open/closed parameter AZP. On account of the handling which is simple and intuitive for a driver, the open/closed parameter AZP is preferably specified as a percentage ratio. Here, the percentage open/closed parameter describes the percentage opening proportion AT_{A} of the open A (or the percentage closed proportion AT_{Z} of the closed Z) switching valve SV in a switching period P of a number of sequential switching periods P_{N}. That is to say, the setting of the speed U_{HR} takes place by means of an open/closed parameter AZP, an open proportion AT_{A} of the open valve state A and/or a closed proportion AT_{Z} of the closed valve state Z in the switching period P being specified. In accordance with this percentage proportion, the resulting speed U_{HR} changes for a height change of the height regulation H_{R}, in particular raising speed U_{H} and/or lowering speed Us, of the vehicle 150 during the height regulation H_{R} out of the reservoir 120, or in the case of lowering.

It can be seen directly from FIG. 3 that the preferred values of the open/closed parameter AZP lie at 30%, 50% and 70%, 50% corresponding with a standard speed and, correspondingly, a value W of 30% relating to a lower speed U_{HR} for a height change of the height regulation H_{R}, in particular raising speed U_{H} and/or lowering speed Us, and, in an analogous manner, the value W of 70% relating to a higher speed U_{HR} for a height change of the height regulation H_{R}, in particular raising speed U_{H} and/or lowering speed Us, relative to the 50% standard speed. The lower or the higher raising speed U_{H} relative to the standard speed results as a consequence from a lower or higher percentage open proportion AT_{A} of the open valve state A of the switching valve SV in a switching period P. Within the context of said three preferred values for the open/closed parameter AZP, it is provided in accordance with the concept of the disclosure, furthermore, for value ranges W_{AZP} around the abovementioned percentage values W to likewise be permitted. That is to say, for example for the 50% value which results in a standard speed, a value range W_{AZP} of from 45% to 55% is permissible. The same applies analogously for the 30% value and the 70% value. In this way, variables which have an influence on the raising and/or lowering operation and are variable during said operations, such as, for example, the air pressure PR in the reservoir 120, can be reacted to in a flexible manner.

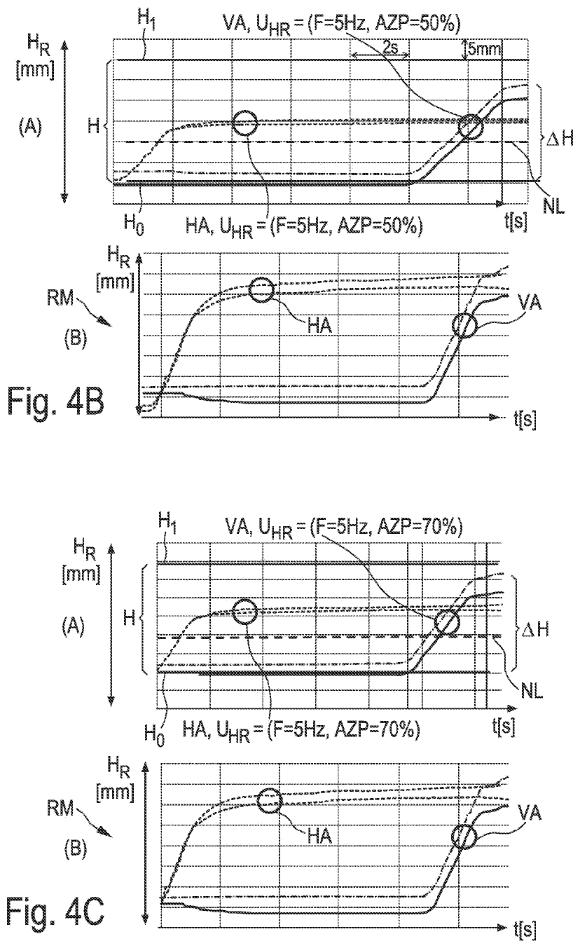

In a view A, using the example of the rear axle HA and the front axle VA for the operation of the height regulation H_{R}, FIG. 4A-FIG. 4D show implicitly, by means of a time-distance diagram, the influence of the frequency F of the switching period P of the number of switching periods P_{N} on the temporal course of the profile of the resulting speed of the height change of the height regulation U_{HR} of the vehicle 150. Furthermore, in the view A, in another illustration, FIG. 4A-FIG. 4D show the influence of the open/closed parameter AZP of the reservoir valve 130.R of the reservoir 120 on the speed which is set of the height change of the height regulation U_{HR}, in the present case using the example of the raising speed U_{H}, on the rear axle HA and on the front axle VA of the vehicle 150. In each case in the view A, FIG. 4A-FIG. 4D show, in addition, the height regulation H_{R} of the rear axle HA and the front axle VA of the vehicle 150 in each case relative to a zero line NL, the height regulation H_{R} starting from a negative value W relative to the zero line NL; here, for example, a vehicle 150 with a high load ZU is to be thought of, and is to be transferred to a positive value W relative to the zero line NL, in order to make necessary ground clearance of the vehicle 150 possible, for example despite high loading ZU.

In the present case, in the view A, FIG. 4A shows the temporal development of the height of the vehicle 150 during the height regulation H_{R} (within a height interval H between a minimum height H₀ and a maximum height H₁), that is to say the speed of the height change of the height regulation U_{HR} is shown. In the present case, the speed of the height regulation U_{HR} is shown as a raising speed U_{H} both on the rear axle HA and on the front axle VA, for a frequency F of the switching period P of 1 Hz and a value W for the open/closed parameter AZP of 50%. It can be seen from the profile which is shown in FIG. 4A, view A, that the raising operation, that is to say the height change ΔH of the vehicle 150 on the rear axle HA, but in particular on the front axle VA, runs in a stepped manner in the case of a frequency F of 1 Hz. This nonuniform, in particular stepped, height regulation H_{R} is not desirable, since this is clearly perceptible by the driver of the vehicle 150. A stepped raising operation is directly to the detriment of the experienced comfort, and is therefore to be avoided. In addition, in a view B, FIG. 4A shows a reference measurement RM of the height regulation H_{R} of the vehicle 150, more precisely of the speed of the height change of the height regulation U_{HR} on the rear axle HA and on the front axle VA. In the case of the reference measurement RM which is shown, the reservoir valve 130.R has not been actuated in accordance with the concept of the disclosure, that is to say, in particular, has not been switched in an actuated manner. As a result, there is an undesirable, jolt-like height change ΔH of the vehicle 150 on the rear axle HA and on the front axle VA.

In the view A, FIG. 4B shows a similar situation as in FIG. 4A, view A, but in the present case the frequency F of the switching period P of 1 Hz has now been increased to 5 Hz. In contrast, the value W for the open/closed parameter AZP has been left at 50%. It can be seen from FIG. 4B, view A that the raising operation of FIG. 4A, view A which has previously proceeded in a stepped manner experiences significant smoothing GL in the case of an increase of the frequency F to a value W of greater than or equal to 5 Hz, both on the rear axle HA and on the front axle VA. As a consequence, the raising operation out of the reservoir 120 advantageously takes place at a frequency F above 5 Hz, in order to design the raising operation, that is to say the height change ΔH of the vehicle 150 on the rear axle HA and on the front axle VA, such that it can be experienced as uniformly as possible by the driver. Once again, in a view B, FIG. 4B likewise shows the reference measurement RM from FIG. 4A, view B. In comparison with the actuation according to the disclosure of the reservoir valve 130.R of FIG. 4B, view A, the undesirable, jolt-like height change ΔH of the vehicle 150 becomes clearly noticeable on the rear axle HA and on the front axle VA of the reference measurement RM.

In each case in the view A, FIG. 4C and FIG. 4D in the present case additionally show how a changed open/closed parameter AZP has an effect on the resulting speed of the height change of the height regulation U_{HR}, that is to say in the present case the raising speed U_{H} on the rear axle HA and on the front axle VA. In the present case, the frequency F of the switching period P is in each case 5 Hz in both cases. Moreover, FIG. 4C, view A shows an open/closed parameter AZP with a value W of 70%; in contrast, FIG. 4D, view A shows an open/closed parameter with a value W of 30%. It can be seen directly from a comparison of FIG. 4B, FIG. 4C and FIG. 4D, in each case in the view A, that the raising operation, that is to say the height change ΔH of the vehicle 150 on the rear axle and on the front axle VA, proceeds more rapidly in the case of a value W of 70% for the open/closed parameter AZP than in the case of the standard value of 50% in FIG. 4B, view A. In addition, a value W of 30% for the open/closed parameter AZP slows down the raising operation in a corresponding manner. An adaptation of the speed of the height change of the height regulation U_{HR}, that is to say in the present case of the raising speed U_{H} on the rear axle HA and on the front axle VA, advantageously takes place where the height level values 170 of the vehicle 150 have to be adapted rapidly, in order to avoid damage of the vehicle 150, or where the height level values 170 of the vehicle 150 have to be adapted slowly, for example while driving at relatively high speeds. For comparison purposes, FIG. 4C and FIG. 4D, in each case in a view B, likewise show the reference measurement RM, relating to the height change ΔH of the vehicle 150 by means of a reservoir valve 130.R which is not switched in an actuated manner, in the case of raising out of the reservoir 120.

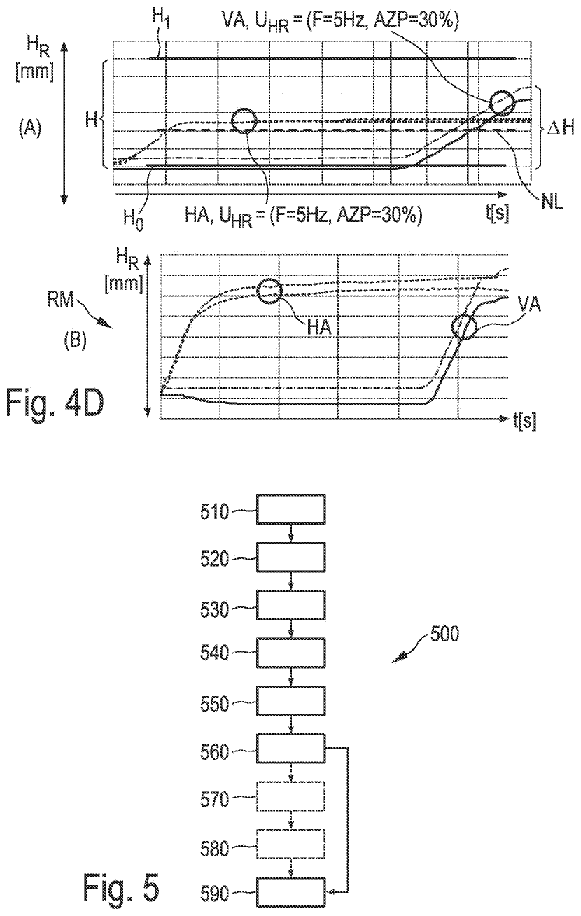

According to FIG. 5, a method for the height regulation H_{R} of a vehicle 150 out of the reservoir 120 is shown diagrammatically. Here, the method comprises the following steps. In a first step, the determining 510 of a starting height H_{S} and of a target height Hz. Furthermore, the consideration 520 of further parameters PA such as the loading ZL of the vehicle 150, the pressure PR in the reservoir, and the like. In addition, checking 530 whether the target height Hz can be reached with consideration of the further parameters PA, and whether the determined target height H_{Z} lies within the permissible height interval H. This step is followed by the specifying 540 of a desired raising speed U_{H} and/or lowering speed U_{S} in order to reach the determined target height Hz. In addition, subsequently, the defining 550 of the open/closed parameter AZP which is necessary for the specified raising speed U_{H} and/or lowering speed Us on the basis of the previously determined vehicle heights 170 and/or parameters PA. Accordingly, in a next step, the actuation 560 of an air spring 110.1 of the number of air springs 110 takes place via the at least one actuated switching valve SV, in particular a bellows valve 130.B or a reservoir valve 130.R or a venting valve 130.E, of the number of switching valves 130 on the basis of the previously determined open/closed parameter AZP, the open/closed parameter AZP being specified as an open proportion AT_{A} of the open valve state A and/or a closed proportion AT_{Z} of the closed valve state Z in the switching period P, and the switching valve SV being opened A and closed Z at a frequency F, with the result that the height regulation H_{R} of the vehicle 150 takes place uniformly, in particular without perceptible graduations ABS. Two optional steps then result in a manner which is dependent on the selected embodiment, it being possible in a first optional step 570 for a separate actuation of the front axle VA and/or rear axle HA to take place and, as an alternative, it also being possible in a second optional step 580 for a separate actuation of individual air springs 110.1 of the number of air springs 110 to take place. In a last step, the closing 590 takes place of the at least one actuated switching valve SV, in particular a bellows valve 130.B or a reservoir valve 130.R or a venting valve 130.E, of the number of switching valves 130 after the desired target height H_{Z} is reached.

The actuation ANS of the at least one switching valve SV, that is to say, in particular, of a bellows valve 130.B and/or a reservoir valve 130.R and/or a venting valve 130.E, of the number of switching valves 130 can also take place in a pulsed manner here. In particular, the actuation ANS can take place via pulse width modulation PWM, for the implementation of the switching period P of the number of sequential switching periods P_{N}.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE CHARACTERS

0.1 air feed
0 filter
1 compressed air feed
2 compressed air connector
3 venting connector
100 air spring system
110 number of air springs
110.1 one air spring
120 reservoir
130 number of switching valves
130.B bellows valve
130.E venting valve
130.R reservoir valve
131 valve block
140 controller
141 switch
150 vehicle
160 gallery
170 height level values
180 lower limit case
190 upper limit case
200 compressed air supply device
210 air compressor (compressor)
230 throttle
230.1 first throttle
230.2 second throttle
240 compressed air supply line
250 main pneumatic line
260 venting line
280 check valve
300 air spring installation
500 method
510, 520, 530, method steps
540, 550, 560,
570, 580, 590
A switching valve open
AB graduation
ANS actuation
AT_{A} open proportion
AT_{Z} closed proportion
AZP open/closed parameter
D dimension
DLV compressed air supply
E venting
F frequency
GL smoothing
H height interval
H₀, H₁ minimum height, maximum height
HA rear axle
H_{R} height regulation
H_{S} starting height
H_{Z} target height
LV air volumetric flow
NL zero line
P switching period
PA parameter
P_{R} pressure in the reservoir
PW pulse width
PWM pulse width modulation
P₁, P₂, P_{N} number of switching periods
U_{HR} speed for a height change of the height regulation
ΔH height change
RM reference measurement
S₁ first switching state
S₂ second switching state
SV switching valve
SWE flow resistance element
t time
U_{H} raising speed
U_{S} lowering speed
V volume of the air dryer
V_{PV} buffer volume
VA front axle
W value
WB_{AZP} value range, open/closed parameter
WB_{F} value range, frequency
Z switching valve closed
ZU vehicle load capacity

1: An electronically open-loop or closed-loop controlled air spring system with a compressed air supply for height regulation of a vehicle, the air spring system comprising:
a number of air springs and a reservoir for the storage of compressed air,
a number of switching valves for height regulation, and
a controller configured to actuate the number of switching valves,
wherein at least one switching valve is actuated with a number of sequential switching periods and switches over in a switching period, between a first switching state with an open valve state and a second switching state with a closed valve state, the switching period of the number of sequential shifting periods having the open valve state and the closed valve state,
wherein the controller is configured to set a speed for a height change of the height regulation, and
wherein the setting of the speed taking place via an open/closed parameter, via which an open proportion of the open valve state and/or a closed proportion of the closed valve state in the switching period can be specified.

2: The air spring system as claimed in claim 1, wherein the at least one switching valve of the number of switching valves is switched in a manner which is actuated in a pulsed way for the implementation of the switching period of the number of sequential switching periods.

3: The air spring system as claimed in claim 1, wherein the number of switching valves comprises a bellows valve, a reservoir valve, and a venting valve of the compressed air supply,
wherein the bellows valve is configured for the height regulation of the vehicle via an air spring of the number of air springs,
wherein the reservoir valve is configured for the height regulation of the vehicle via the reservoir, and
wherein the venting valve of the compressed air supply is configured for the height regulation of the vehicle via venting of the compressed air supply.

4: The air spring system as claimed in claim 1, wherein the open/closed parameter comprises an absolute specification of the open proportion of the open valve state and/or the closed proportion of the closed valve state in the switching period.

5: The air spring system as claimed in claim 1, wherein the open/closed parameter comprises a relative specification of the open proportion of the open valve state and/or the closed proportion of the closed valve state in the switching period.

6: The air spring system as claimed in claim 1, wherein the dimension of the open/closed parameter indicates the open proportion of the open valve state and the closed proportion of the closed valve state in the switching period in percent.

7: The air spring system as claimed in claim 6, wherein the open/closed parameter assumes a value from the value range between 65% and 75%.

8: The air spring system as claimed in claim 1, wherein the value of the open/closed parameter is variable during the height regulation of the vehicle, with the result that the speed of the height regulation of the vehicle is selectively constant or variable.

9: The air spring system as claimed in claim 1, wherein the frequency of the switching period of the actuation of the at least one switching valve of the number of switching valves is defined in such a way that the height regulation of the vehicle takes place uniformly.

10: The air spring system as claimed in claim 9, wherein the frequency of the switching period is selected from a value range comprising the values of greater than or equal to 5 Hz and less than or equal to 20 Hz.

11: An air spring installation, comprising:
an air spring system as claimed in claim 1,
a compressed air supply system, with a compressed air feed, a compressed air connector, a main pneumatic line between the compressed air feed and the compressed air connector, which main pneumatic line has an air dryer, and
a compressed air supply line, between the compressed air connector and the air spring system, and
a venting connector, and a venting line between the compressed air feed and the venting connector, which venting line comprises a venting valve,
wherein the main pneumatic line and/or the compressed air supply line include at least one throttle or flow resistance element,
wherein the venting valve is configured to be actuated,
wherein the controller is further configured to actuate the venting valve and to set the lowering speed of the height regulation,
wherein setting of the lowering speed of the height regulation takes place via the open/closed parameter, and
wherein the throttle or flow resistance element is configured for the smoothing of the raising speed and/or the lowering speed of the height regulation of the vehicle.

12: The air spring installation as claimed in claim 11, wherein the at least one throttle or flow resistance element is arranged in the main pneumatic line between the air dryer and the compressed air connector and/or in the compressed air supply line between the compressed air connector and the air spring system.

13: A method for the height regulation of a vehicle via an air spring system, the method comprising:
determining a starting height and a target height;
checking whether the target height can be reached and whether the determined target height lies within a permissible height interval;
specifying a desired raising speed and/or lowering speed for achieving the determined target height;
defining the open/closed parameter on the basis of the previously determined vehicle heights via which open/closed parameter the speed is set;
actuating an air spring of a number of air springs via at least one actuated switching valve of the number of switching valves based on the previously determined open/closed parameter, the open/closed parameter being specified as an open proportion of the open valve state and/or a closed proportion of the closed valve state in the switching period.

14: The method as claimed in claim 13,
wherein determining a starting height and a target height and/or checking whether the target height can be reached and/or defining of the open/closed parameter which is necessary for the specified speed take/takes place based on the previously determined vehicle heights, and taking place with consideration of further parameters.

15: The method as claimed in claim 13, further comprising closing the at least one actuated switching valve of the number of switching valves after the desired target height is reached.

16: The method as claimed in claim 13, wherein the actuation of the at least one switching valve of the number of switching valves takes place in a pulsed manner for the implementation of the switching period of the number of sequential switching periods.

17: The method as claimed in claim 16, wherein the at least one switching valve, which is actuated in a pulsed manner of the number of switching valves being actuated in a pulsed manner with a frequency, based on the previously determined open/closed parameter, the open/closed parameter being specified as an open proportion of the open valve state and/or a closed proportion of the closed valve state in the switching period, with the result that the height regulation of the vehicle takes place uniformly.

18: The method as claimed in claim 13, wherein a separate actuation of the front axle and/or rear axle takes place, and/or a separate actuation of individual air springs of the number of air springs takes place.
